(19) United States
(12) Patent Application Publication
(10) Pub. No.: US 2026/0157920 A1
(43) Pub. Date: Jun. 11, 2026

(54) MALE MASTURBATOR WITH TELESCOPING AND ROTATING MECHANISM

(71) Applicant: Dongguan Yixu Technology Co., Ltd., Dongguan (CN)

(72) Inventor: Xudong LI, Dongguan (CN)

(73) Assignee: Dongguan Yixu Technology Co., Ltd., Dongguan (CN)

(21) Appl. No.: 18/974,689

(22) Filed: Dec. 9, 2024

(51) Int. Cl. A61H 19/00

(52) U.S. Cl. CPC A61H 19/32; A61H 2201/0111; A61H 2201/1669; A61H 2201/1673

(57) ABSTRACT

The disclosure discloses a male masturbator with a telescoping and rotating mechanism. A driving unit includes an eccentric wheel, a pull rod, a telescoping sleeve, a rotating sleeve, a rotating and telescoping barrel, a driving member, a bearing fixing member, a gearbox upper casing fixing member, a gearbox lower casing fixing member and a gearbox. The gearbox upper casing fixing member and the gearbox lower casing fixing member are correspondingly fixed to upper and lower sides of the gearbox respectively. The eccentric wheel is connected to the gearbox in a driving manner. A surface of the eccentric wheel is provided with a protrusion. The protrusion is connected to the pull rod. The driving member is connected to the gearbox in a driving manner. The male masturbator with a telescoping and rotating mechanism has the advantages of better user experience and lower noise and vibration.

### BACKGROUND

### 1. Technical Field

The disclosure relates to the technical field of adult products, and in particular to an improvement of a male masturbator with a telescoping and rotating mechanism.

### 2. Background Information

In the field of existing adult products, especially simulation adult products, the improvement of their functions and experience is limited by the structure. The existing products on the market are deficient in the simulation of real human movements, and there is a lack of an integrated mechanism that can effectively realize telescoping and rotating movements, so as to better meet the needs of users for diversification and experience like real human movements. The traditional design is typically complicated and inflexible in structure or unnatural in movements, which cannot provide the users with smooth and real experience.

At present, male masturbators are the best-selling male adult products. A male masturbator typically does massage by vibration and reciprocation with soft rubber. However, the transmission mechanism of an ordinary male masturbator is relatively simple, may be stuck and not easily return to its original position during reciprocation, and produces noise and additional vibration, thereby affecting the user experience and reducing the use effect of the male masturbator.

### BRIEF SUMMARY

### (I) Technical problem to be solved

In view of the deficiency in the prior art, the disclosure provides a male masturbator with a telescoping and rotating mechanism, which has the advantages of better user experience and lower noise and vibration, thereby solving the problem that the transmission mechanism of an ordinary male masturbator is relatively simple, may be stuck and not easily return to its original position during reciprocation, and produces noise and additional vibration, thereby affecting the user experience and reducing the use effect of the male masturbator.

### (II) Technical solution

In order to achieve the advantages of better user experience and lower noise and vibration, the disclosure specifically adopts the following technical solution:

A male masturbator with a telescoping and rotating mechanism includes a main body casing, a driving unit, a massage part and a control unit. The main body casing includes a main body upper casing, a main body lower casing, a decorative upper casing, a decorative lower casing, a transparent member and a display screen transparent member that are assembled and mounted with each other to form a mounting cavity. The driving unit includes an eccentric wheel, a pull rod, a telescoping sleeve, a rotating sleeve, a rotating and telescoping barrel, a driving member, a bearing fixing member, a gearbox upper casing fixing member, a gearbox lower casing fixing member and a gearbox. The gearbox upper casing fixing member and the gearbox lower casing fixing member are correspondingly fixed to upper and lower sides of the gearbox respectively. The eccentric wheel is connected to the gearbox in a driving manner. A surface of the eccentric wheel is provided with a protrusion. The protrusion is connected to the pull rod. The driving member is connected to the gearbox in a driving manner. The rotating sleeve slidably telescopes on a surface of the driving member. The pull rod is sleeved with a balancing shaft. There are two balancing shafts arranged horizontally. The telescoping sleeve is sleeved on the other balancing shaft. The bearing fixing member is mounted inside the telescoping sleeve. The bearing fixing member is provided with a bearing therein and limits the other end of the rotating and telescoping barrel. The rotating sleeve is connected to the telescoping sleeve through a bearing. The rotating sleeve is provided with a guide seat. The driving member is provided with a guide groove.

The control unit includes a PCBA board, a PCBA touchpad and a lithium polymer battery. The lithium polymer battery is electrically connected to the PCBA board. The PCBA touchpad is arranged on a surface of the main body upper casing. The PCBA board is provided with a PCB waterproof ring. The lithium polymer battery is connected to a waterproof Type-C female connector. A Type-C waterproof dust plug is provided in the waterproof Type-C female connector.

Further, a magnet is arranged inside the rotating and telescoping barrel, and the magnet is fixedly mounted at a center of the rotating sleeve.

Further, the massage part includes a soft rubber, an outer side of the soft rubber is provided with a massage part fixing cover, the massage part fixing cover is connected with a body lid, and an end of the soft rubber close to the rotating sleeve is provided with a second magnet magnetically adsorbed to the magnet.

Further, the surface of the driving member is provided with a ball groove matched with the guide groove, the ball groove is provided as a slope, a ball is arranged in the ball groove, and the ball is connected in the guide groove and a ball groove rotating cavity in a rolling manner.

Further, the gearbox is a waterproof gearbox, and is provided with a motor waterproof ring and a motor casing waterproof ring inside.

Further, at least one magnetite or metal sheet is arranged between the rotating and telescoping barrel and the soft rubber. The at least one magnetite or metal sheet is used for connection through adsorption, thereby completing the assembly.

Further, a vibrating motor is arranged inside the soft rubber, and the soft rubber is made of TPE.

### (III) Beneficial effects

Compared with the prior art, the disclosure provides a male masturbator with a telescoping and rotating mechanism, which has the following beneficial effects:

The eccentric wheel is connected to the gearbox in a driving manner, the surface of the eccentric wheel is provided with the protrusion, the protrusion is connected to the pull rod, and the eccentric wheel pushes the pull rod to drive the telescoping sleeve to telescope. The surface of the driving member is provided with the ball groove matched with the guide groove, the ball groove is provided as a slope, the ball is arranged in the ball groove, and the ball is connected in the guide groove and the ball groove rotating cavity in a rolling manner. The ball rolls in the ball groove, so that the rotating and telescoping barrel can rotate and slide on the driving member, thereby driving the soft rubber to rotate and telescope, and improving the use effect. The control unit is mounted on the main body, and configured to control and drive a working state of the gearbox. The soft rubber and the rotating sleeve are connected through the adsorption of the magnet, which facilitates the demounting of the soft rubber. The control unit provides power support for the whole device. The user can choose among different massage modes and strengths according to needs, thereby effectively massaging all parts of the body.

### BRIEF DESCRIPTION OF THE DRAWINGS

In order to more clearly illustrate the examples of the disclosure or the technical solutions in the prior art, the accompanying drawings used in the examples will be briefly described below. Apparently, the accompanying drawings in the following description are only some examples of the disclosure, and those skilled in the art can obtain other drawings according to these accompanying drawings without any creative work.

FIG. 1 is a schematic structural exploded view of the disclosure;

FIG. 2 is a schematic structural view of a main body casing of the disclosure;

FIG. 3 is a schematic structural view of a driving unit of the disclosure;

FIG. 4 is a schematic structural view of a rotating sleeve 12 and a rotating and telescoping barrel 13 of the disclosure;

FIG. 5 is a schematic structural view of a gearbox 30 and a driving member 14 of the disclosure;

FIG. 6 is a schematic structural view of the driving unit of the disclosure; and

FIG. 7 is a schematic structural view of the disclosure.

In the figures: main body upper casing 1, main body lower casing 2, decorative upper casing 3, decorative lower casing 4, transparent member 5, display screen transparent member 6, massage part fixing cover 7, body lid 8, eccentric wheel 9, pull rod 10, telescoping sleeve 11, rotating sleeve 12, rotating and telescoping barrel 13, driving member 14, bearing fixing member 16, bearing 17, gearbox upper casing fixing member 18, gearbox lower casing fixing member 19, soft rubber 24, ball 25, PCBA board 26, PCBA touchpad 27, lithium polymer battery 28, gearbox 30, balancing shaft 32, motor waterproof ring 33, motor casing waterproof ring 36, guide seat 121, guide groove 122.

### DETAILED DESCRIPTION OF THE DRAWINGS AND THE PRESENTLY PREFERRED EMBODIMENTS

To further illustrate the examples, the accompanying drawings are provided in the disclosure. These accompanying drawings are a part of the contents disclosed in the disclosure that are mainly used to illustrate the examples, and can be used in conjunction with the related descriptions in the specification to explain the operation principle of the examples. With reference to these contents, those of ordinary skill in the art should be able to understand other possible embodiments and advantages of the disclosure. Components in the drawings are not drawn to scale, and like component symbols are usually used to represent like components.

An example of the disclosure provides a male masturbator with a telescoping and rotating mechanism.

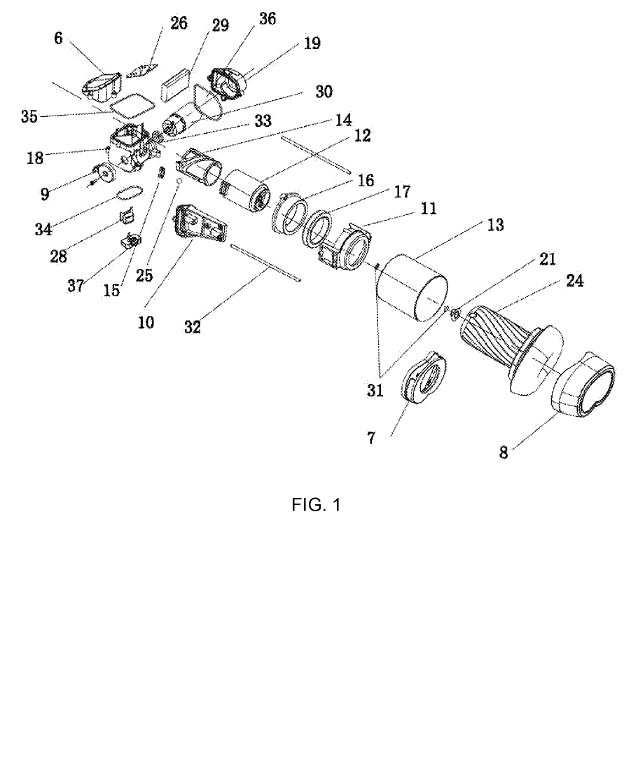

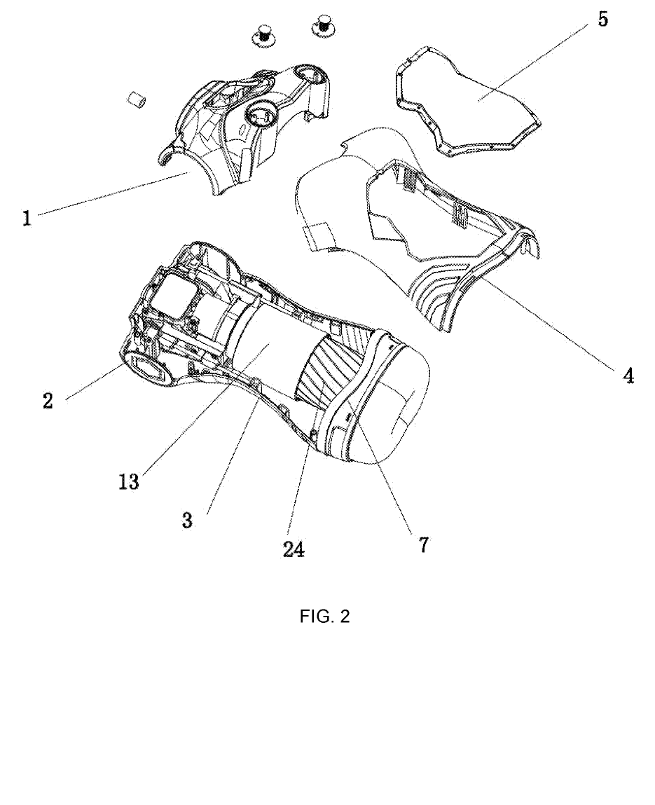

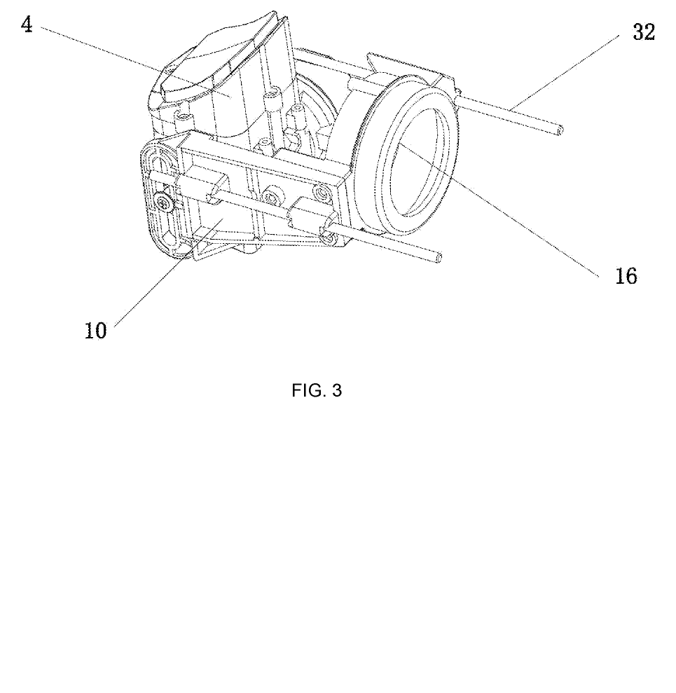

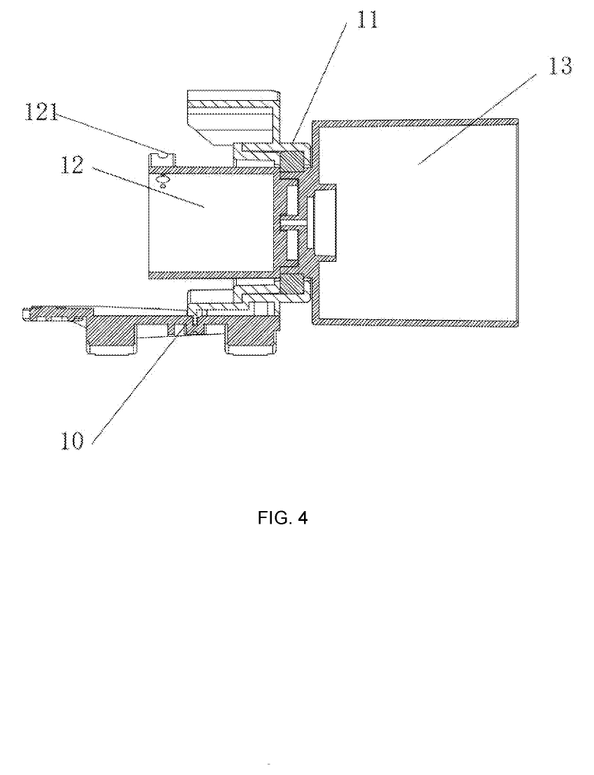

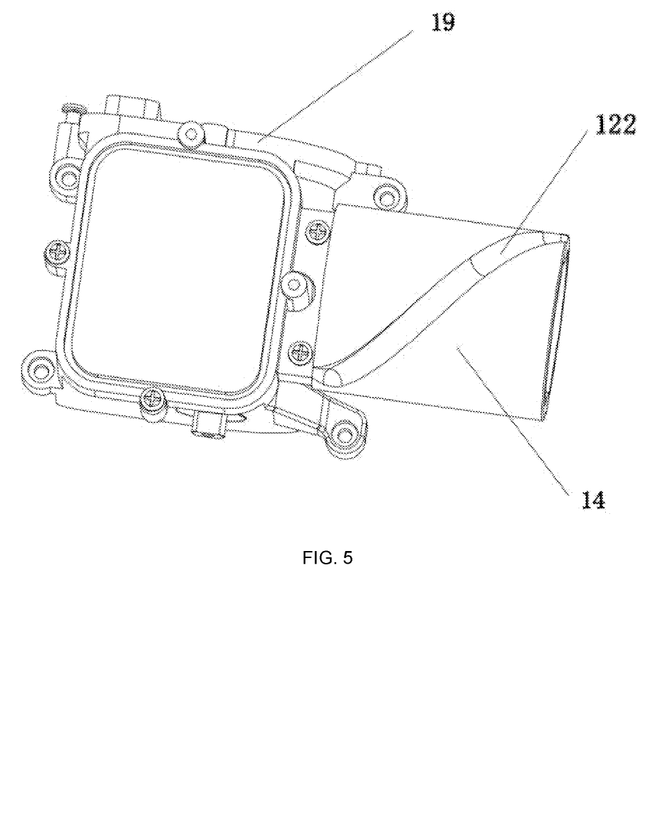

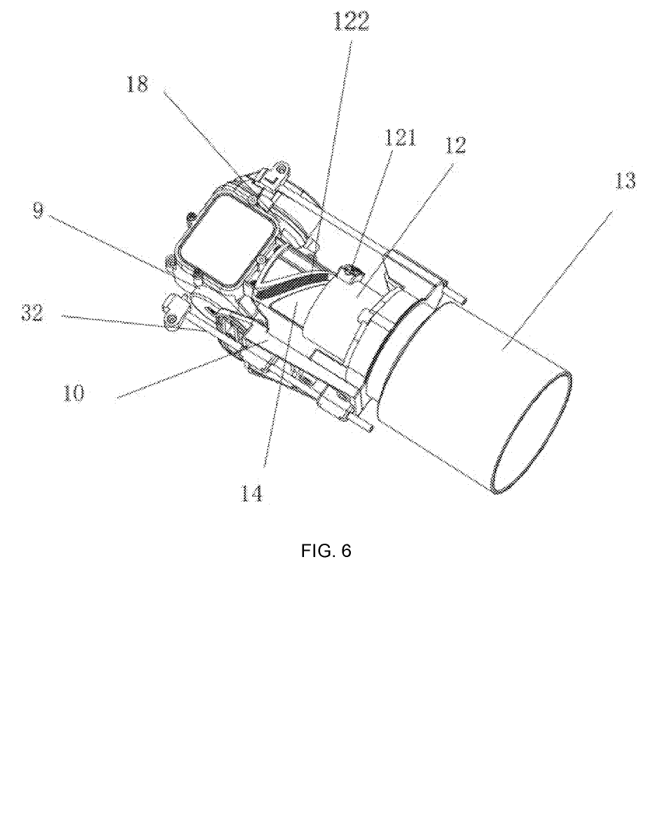

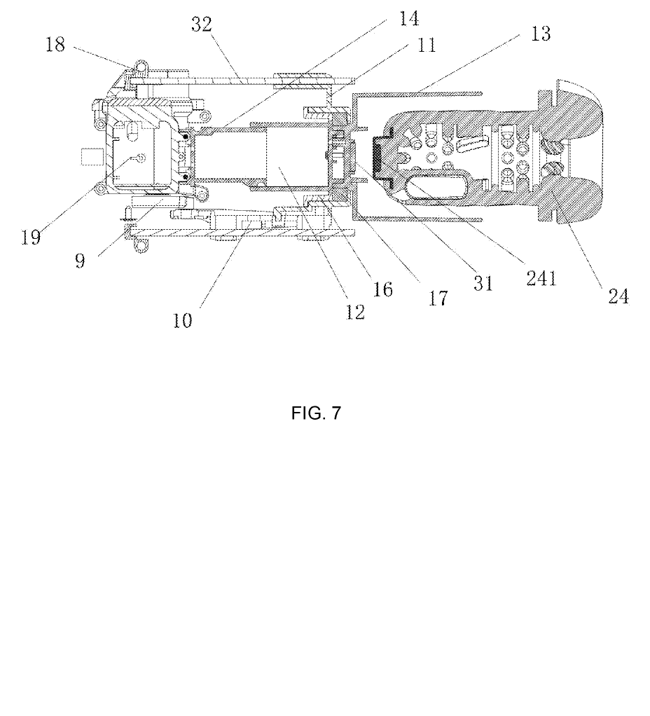

The disclosure will be further described in conjunction with the accompanying drawings and specific embodiments. As shown in FIG. 1 to FIG. 7, the male masturbator with a telescoping and rotating mechanism according to an example of the disclosure includes a main body casing, a driving unit, a massage part and a control unit. The main body casing includes a main body upper casing 1, a main body lower casing 2, a decorative upper casing 3, a decorative lower casing 4, a transparent member 5 and a display screen transparent member 6 that are assembled and mounted with each other to form a mounting cavity. The driving unit includes an eccentric wheel 9, a pull rod 10, a telescoping sleeve 11, a rotating sleeve 12, a rotating and telescoping barrel 13, a driving member 14, a bearing fixing member 16, a gearbox upper casing fixing member 18, a gearbox lower casing fixing member 19 and a gearbox 30. The gearbox upper casing fixing member 18 and the gearbox lower casing fixing member 19 are correspondingly fixed to upper and lower sides of the gearbox 30 respectively. The eccentric wheel 9 is connected to the gearbox 30 in a driving manner. A surface of the eccentric wheel 9 is provided with a protrusion. The protrusion is connected to the pull rod 10. The driving member 14 is connected to the gearbox 30 in a driving manner. The rotating sleeve 12 slidably telescopes on a surface of the driving member 14. The pull rod 10 is sleeved with a balancing shaft 32. There are two balancing shafts 32 arranged horizontally. The telescoping sleeve 11 is sleeved on the other balancing shaft 32. The bearing fixing member 16 is mounted inside the telescoping sleeve 11. The bearing fixing member 16 is provided with a bearing 17 therein and limits the other end of the rotating and telescoping barrel 13. The rotating sleeve 12 is connected to the telescoping sleeve 11 through a bearing 17. The rotating sleeve 12 is provided with a guide seat 121. The driving member 14 is provided with a guide groove 122. The eccentric wheel 9 is connected to the gearbox 30 in a driving manner, the surface of the eccentric wheel 9 is provided with the protrusion, the protrusion is connected to the pull rod 10, and the eccentric wheel 9 pushes the pull rod 10 to drive the telescoping sleeve 11 to telescope. The control unit is mounted on the main body, and configured to control and drive a working state of the gearbox 30. The control unit provides power support for the whole device. The user can choose among different massage modes and strengths according to needs.

In an example, the control unit includes a PCBA board 26, a PCBA touchpad 27 and a lithium polymer battery 28, the lithium polymer battery 28 is electrically connected to the PCBA board 26, the PCBA touchpad 27 is arranged on a surface of the main body upper casing 1, the PCBA board 26 is provided with a PCB waterproof ring 35, the lithium polymer battery 28 is connected to a waterproof Type-C female connector, and a Type-C waterproof dust plug 37 is provided in the waterproof Type-C female connector.

In an example, a magnet 31 is arranged inside the rotating and telescoping barrel 13, and the magnet 31 is fixedly mounted at a center of the rotating sleeve 12.

In an example, the massage part includes a soft rubber 24, an outer side of the soft rubber 24 is provided with a massage part fixing cover 7, the massage part fixing cover 7 is connected with a body lid 8, and an end of the soft rubber 24 close to the rotating sleeve 12 is provided with a second magnet 241 magnetically adsorbed to the magnet 31. The soft rubber 24 and the rotating sleeve 12 are connected through the adsorption of the magnet 31, which facilitates the demounting of the soft rubber 24.

In an example, the surface of the driving member 14 is provided with a ball groove matched with the guide groove 122, the ball groove is provided as a slope, a ball 25 is arranged in the ball groove, and the ball 25 is connected in the guide groove 122 and a ball groove rotating cavity in a rolling manner. The ball 25 rolls in the ball groove, so that the rotating and telescoping barrel 13 can rotate and slide on the driving member 14, thereby driving the soft rubber 24 to rotate and telescope, and improving the use effect.

In an example, the gearbox 30 is a waterproof gearbox, and is provided with a motor waterproof ring 33 and a motor casing waterproof ring 36 inside. This reduces the occurrence of water leakage inside the gearbox 30.

In an example, at least one magnetite or metal sheet is arranged between the rotating and telescoping barrel 13 and the soft rubber 24. The at least one magnetite or metal sheet is used for connection through adsorption, thereby completing the assembly.

In an example, a vibrating motor is arranged inside the soft rubber 24, and the soft rubber 24 is made of TPE. With the vibrating motor, the soft rubber 24 has the vibration effect.

Working principle: The eccentric wheel 9 is connected to the gearbox 30 in a driving manner, the surface of the eccentric wheel 9 is provided with the protrusion, the protrusion is connected to the pull rod 10, and the eccentric wheel 9 pushes the pull rod 10 to drive the telescoping sleeve 11 to telescope. The surface of the driving member 14 is provided with the ball groove matched with the guide groove 122, the ball groove is provided as a slope, the ball 25 is arranged in the ball groove, and the ball 25 is connected in the guide groove 122 and the ball groove rotating cavity in a rolling manner. The ball 25 rolls in the ball groove, so that the rotating sleeve 12 can rotate and slide on the driving member 14, thereby driving the soft rubber 24 to rotate and telescope, and improving the use effect. The control unit is mounted on the main body, and configured to control and drive a working state of the gearbox 30. The soft rubber 24 and the rotating and telescoping barrel 13 are connected through the adsorption of the magnet 31, which facilitates the demounting of the soft rubber 24. The control unit provides power support for the whole device. The user can choose among different massage modes and strengths according to needs, thereby effectively massaging all parts of the body.

In the disclosure, unless otherwise explicitly specified and defined, the terms "mounting", "arrangement", "connection", "fixing", "screwing" and the like shall be understood broadly, and may be, for example, a fixed connection, a detachable connection or integration; may be a mechanical connection or an electrical connection; or may be a direct connection, an indirect connection through an intermediate medium, or an internal communication between two elements or interaction between two elements. Unless otherwise specified, for those of ordinary skill in the art, the specific meaning of the above terms in the disclosure can be understood in specific cases.

The above description is merely preferred examples of the disclosure and is not intended to limit the disclosure. Any modifications, equivalent substitutions and improvements made within the spirit and principles of the disclosure shall be included within the protection scope of the disclosure.

1. A male masturbator with a telescoping and rotating mechanism, comprising a main body casing, a driving unit, a massage part and a control unit, wherein the main body casing comprises a main body upper casing, a main body lower casing, a decorative upper casing, a decorative lower casing, a transparent member and a display screen transparent member that are assembled and mounted with each other to form a mounting cavity; the driving unit comprises an eccentric wheel, a pull rod, a telescoping sleeve, a rotating sleeve, a rotating and telescoping barrel, a driving member, a bearing fixing member, a gearbox upper casing fixing member, a gearbox lower casing fixing member and a gearbox, the gearbox upper casing fixing member and the gearbox lower casing fixing member are correspondingly fixed to upper and lower sides of the gearbox respectively, the eccentric wheel is connected to the gearbox in a driving manner, a surface of the eccentric wheel is provided with a protrusion, the protrusion is connected to the pull rod, the driving member is connected to the gearbox in a driving manner, the rotating sleeve slidably telescopes on a surface of the driving member, the pull rod is sleeved with a balancing shaft, there are two balancing shafts arranged horizontally, the telescoping sleeve is sleeved on the other balancing shaft, the bearing fixing member is mounted inside the telescoping sleeve, the bearing fixing member is provided with a bearing therein and limits the other end of the rotating and telescoping barrel, the rotating sleeve is connected to the telescoping sleeve through a bearing, the rotating sleeve is provided with a guide seat, and the driving member is provided with a guide groove; and
the control unit comprises a PCBA board, a PCBA touchpad and a lithium polymer battery, the lithium polymer battery is electrically connected to the PCBA board, the PCBA touchpad is arranged on a surface of the main body upper casing, the PCBA board is provided with a PCB waterproof ring, the lithium polymer battery is connected to a waterproof Type-C female connector, and a Type-C waterproof dust plug is provided in the waterproof Type-C female connector.

2. The male masturbator with a telescoping and rotating mechanism according to claim 1, wherein a magnet is arranged inside the rotating and telescoping barrel, and the magnet is fixedly mounted at a center of the rotating sleeve.

3. The male masturbator with a telescoping and rotating mechanism according to claim 1, wherein the massage part comprises a soft rubber, an outer side of the soft rubber is provided with a massage part fixing cover, the massage part fixing cover is connected with a body lid, and an end of the soft rubber close to the rotating sleeve is provided with a second magnet magnetically adsorbed to the magnet.

4. The male masturbator with a telescoping and rotating mechanism according to claim 1, wherein the surface of the driving member is provided with a ball groove matched with the guide groove, the ball groove is provided as a slope, a ball is arranged in the ball groove, and the ball is connected in the guide groove and a ball groove rotating cavity in a rolling manner.

5. The male masturbator with a telescoping and rotating mechanism according to claim 1, wherein the gearbox is a waterproof gearbox, and is provided with a motor waterproof ring and a motor casing waterproof ring inside.

6. The male masturbator with a telescoping and rotating mechanism according to claim 1, wherein at least one magnetite or metal sheet is arranged between the rotating and telescoping barrel and the soft rubber.

7. The male masturbator with a telescoping and rotating mechanism according to claim 1, wherein a vibrating motor is arranged inside the soft rubber, and the soft rubber is made of TPE.
